(19) United States
(12) Patent Application Publication
(10) Pub. No.: US 2017/0182850 A1
(43) Pub. Date: Jun. 29, 2017

(54) PNEUMATIC TIRE

(71) Applicant: TOYO TIRE & RUBBER CO., LTD., Osaka (JP)

(72) Inventor: Yuichi Nakamura, Osaka-shi (JP)

(73) Assignee: TOYO TIRE & RUBBER CO., LTD., Osaka (JP)

(21) Appl. No.: 15/285,175

(22) Filed: Oct. 4, 2016

(30) Foreign Application Priority Data
Dec. 25, 2015 (JP) 2015-253365

(51) Int. Cl. B60C 11/11; B60C 11/12

(52) U.S. Cl. CPC B60C 11/11; B60C 11/1236; B60C 2011/0353

(57) ABSTRACT

A pneumatic tire in a plurality of land portions formed by partitioning the tread portion by groove portions including a plurality of circumferential-direction grooves extending in a circumferential direction and a plurality of width-direction grooves extending in a width direction, and at least one sipe is formed on the land portion. Assuming a length component of the groove portion in the width direction per a unit area on an edge of a tread surface as a width-direction groove component, assuming a length component of the groove portion in the circumferential direction per the unit area on the edge of the tread surface as a circumferential-direction groove component, assuming a length component of the sipe the width direction per the unit area on the tread surface as a width-direction sipe component. The width-direction groove component is larger than the circumferential-direction groove component and the width-direction sipe component.

### CROSS-REFERENCE TO RELATED APPLICATIONS

This application claims priority or Japanese Patent Application No.: 2015-253365 filed on Dec. 25, 2015, the content of which is incorporated herein by reference.

### BACKGROUND OF THE INVENTION

The present invention a pneumatic tire.

### RELATED ART

Conventionally, with respect to a pneumatic tire for a light truck, to ensure a higher internal pressure and a higher load compared to vehicle-use tire and also to ensure wear resistance, there has been adopted a pneumatic tire having a groove shape which is determined by taking into account ventilation property so as to suppress the lowering of the block rigidity or to suppress the generation of heat.

For example, JP-A-2006-160195 discloses a pneumatic tire where a tread portion is partitioned into a plurality of block or by a plurality of circumferential-direction grooves extending in a circumferential direction and a plurality of width-direction grooves intersecting with the circumferential-direction grooves, and shallow grooves are formed on each block portion, and zigzag-shaped sipes are formed on a bottom of each shallow groove. With such a configuration, the opening of the shallow grooves is suppressed and hence, the rigidity of the block portions is enhanced whereby wear resistance is improved. On the other hand, JP-A-2014-521548 discloses a pneumatic tire where a portion is partitioned into a plurality of block portions by a plurality of circumferential-direction grooves extending in a circumferential direction and a plurality of width-direction grooves intersecting with the circumferential-direction grooves, and an average void ratio of the tread portion is limited. With such a configuration, it is possible to suppress the generation of heat by ensuring ventilation property.

On the other hand, there has been also known a pneumatic tire where a large number of sipes are formed on each block portion for ensuring traction performance on a snowy road (hereinafter referred to as snow traction performance). However, when the large number of sipes are formed on each block portion, the rigidity of the block portion is largely and easily lowered. Particularly, with respect to a pneumatic tire for a light truck having a high internal pressure and a high load, chippings or cracks are liable to occur in the block portions and hence, external flaw resistance is deteriorated.

### SUMMARY

The present invention has been made in view of the above-mentioned drawbacks, and it is an object of the present invention to provide a pneumatic tire which can acquire both the enhancement of snow traction performance and the enhancement of external flaw resistance.

An aspect of the present invention provides a pneumatic tire where a tread portion includes a plurality of land portions formed by partitioning the tread portion by groove portions in a plurality of circumferential-direction grooves extending in a circumferential direction and a plurality of width-direction grooves extending in a width direction, and at least one sipe is formed on the land portion, wherein assuming a length component of the groove portion in the width direction per a unit area on an edge of a tread surface as a width-direction groove component, assuming a length component of the groove portion in the circumferential direction per the unit area on the edge of the tread surface as a circumferential-direction groove component, assuming a length component of the sipe in the width direction per the unit area on the tread surface as a width-direction sipe component, and the width-direction groove component is larger than the circumferential-direction groove component and the width-direction sipe component.

The meaning of “circumferential-direction groove” and the meaning of “width-direction groove” are grooves which are formed by casting using a tire vulcanization mold, and have a groove width (for example, not smaller than 2.0 mm, and more preferably, not smaller than 2.5 mm) which does not allow groove walls in easily close the groove when the pneumatic tire is brought into contact with a ground. The circumferential-direction grooves and the width-direction grooves also include slits besides main grooves extending in a tire circumferential direction, and lug grooves extending in a tire width direction, for example. The meaning of “sips” is a cut which is formed by a vulcanization mold (for example, a cut formed by sipe forming plate), and has a groove width (for example, not larger than 2.0 mm, and more preferably, not larger than 1.5 mm) which allows groove walls to easily close the groove when the pneumatic tire is brought into contact with a ground. The meaning of “circumferential direction” is a tire circumferential direction, and the meaning of “width direction” is a tire width direction. Land portions include blocks and ribs.

According to the present invention, the width-direction groove component is larger than the circumferential-direction groove component and hence, it is possible to easily ensure a width-direction edge component on a tread surface by an edge portion formed between the groove portion and the tread surface whereby traction performance can be enhanced. Particularly, traction performance on a snowy road can be easily ensured and hence, the pneumatic tire exhibits excellent snow traction performance. Accordingly, it is unnecessary to form a large number of sipes for enhancing traction performance and hence, the deterioration of external flaw resistance of the land portions caused by the sipes can be suppressed. As a result, the pneumatic tire of the present invention can acquire both the enhancement of snow traction performance and the enhancement of external flaw resistance.

Assuming a length component of the sipe in the circumferential direction per the unit area on the tread surface as a circumferential-direction sipe component, preferably the width-direction sipe component is larger than the circumferential-direction sipe component.

With such a configuration, the width-direction edge component formed by the sipe can be easily ensured and hence, the snow traction performance can be further enhanced.

Preferably, the circumferential-direction groove extends in a jig-zag shape such that a see-through void becomes zero.

The meaning of “see-through void” is a ratio of an area where the land portion is not present when the circumferential-direction groove is viewed in the tire-circumferential direction. With such a configuration, the width-direction edge component of the circumferential-direction groove can be increased and hence, the snow traction performance can be further enhanced.

Preferably, the width-direction groove component is set a value which is not smaller than 0.010 mm/mm² and not larger than 0.040 mm/mm².

With such a configuration, the groove portion includes a proper width-direction groove component and hence, it is possible to suppress the deterioration of external flaw resistance while snow traction is enhanced. When a width-direction groove component is less than 0.010 mm/mm², the traction performance is liable to become insufficient. On the other hand, when the width-direction groove component is larger than 0.040 mm/mm², the rigidity of the land portion is liable to be lowered and hence, an effect of suppressing the deterioration of external flaw resistance is lowered.

Preferably, a ground contact shape of the tread portion is set such that an effective ground contact area is set to a value which is not smaller than 65% and not larger than 75% of an area of a whole region of the ground contact shape, and a circumferential-direction ground contact length on a width-direction ground contact edge portion is set to a value which is not smaller than 75% and not larger than 85% of the circumferential-direction ground contact length on a tire equator.

The meaning of “effective ground contract area” is an area of a portion of the tread portion which is brought into contact with a road surface. To be more specific, the meaning of “effective ground contact area” is a ground contact area of a ground contact portion (land portion) which is obtained by excluding void portions (air gap portions) formed by the groove portions and the like from the whole region of the ground contact shape. With such a configuration, the pneumatic tire of the present invention can ensure a proper ground contact surface shape while acquiring both the enhancement of the snow traction performance and the enhancement of the external flaw resistance. Accordingly, the pneumatic tire of the present invention can suppress the deterioration of steering stability and uneven wear resistance.

The pneumatic tire of the present invention can acquire both the enhancement of the snow traction performance and the enhancement of the external flaw resistance.

### BRIEF DESCRIPTION OF THE DRAWINGS

The foregoing and the other features of the present invention will become apparent from the following description and drawings of an illustrative embodiment of the invention in which:

FIG. 1 is a meridian sectional view of a pneumatic tire according to one embodiment of the present invention;

FIG. 2 is a plan view showing a tread pattern in a developed state;

FIG. 3 is a partially enlarged view of a basic pattern in FIG. 2 schematically showing width-direction groove components;

FIG. 4 is a partially enlarged view of the basic pattern in FIG. 2 schematically showing circumferential-direction groove components;

FIG. 5 is a partially enlarged view of the basic pattern in FIG. 2 schematically showing width-direction sipe components and circumferential-direction sipe components;

FIG. 6 is a partially enlarged view of the basic pattern in FIG. 2 schematically showing all sipe components; and

FIG. 7 is a plan view showing a tread pattern according to a modification in a developed state.

### DETAILED DESCRIPTION OF EMBODIMENTS

Hereinafter, embodiments according to the present invention are described with reference to attached drawings. The description made hereinafter is provided substantially for merely illustrating the present invention, and the description does not intend to limit the present invention, a product to the present invention is applied or a usage where the present invention is used. Further, drawings are schematic drawings, and ratios between the respective sizes and the like may differ from actual corresponding ratios and the like. In the description made hereinafter, the meaning of “outside in the tire width direction” is the direction toward an edge portion side of a tread portion in the tire width direction from a tire equator, and the meaning of “inside in the tire width direction” is the direction toward a tire equator side from the edge portion of the tread portion in the tire width direction.

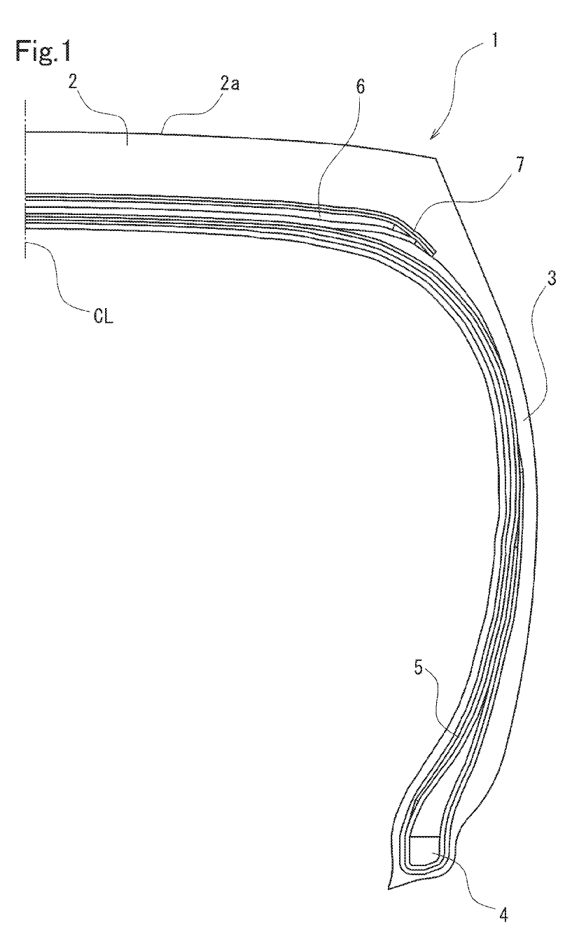

FIG. 1 is a meridian half sectional view of a pneumatic tire 1 for a light truck according to one embodiment of the present in FIG. 1 snows only one side of the cross section with respect to a tire equator CL. As shown in FIG. 1, the pneumatic tire 1 includes a tread portion 2 which forms a tread surface 2a, a pair of side wall portions 3 which extends toward the inside in the tire radial direction from both edges of the tread portion 2, and bead portions 4 which are respectively positioned at inner diameter ends of the side wall portions 3, 3.

The pneumatic tire 1 includes three carcass plies 5 which extend between the respective bead portions 4, 4 such that three carcass plies 3 also extend over the tread portion 2 and the side wall portions 3. Two reinforcing belt layers 6 and two reinforcing layers 7 are disposed outside the carcass ply 5 in the tire radial direction in this order.

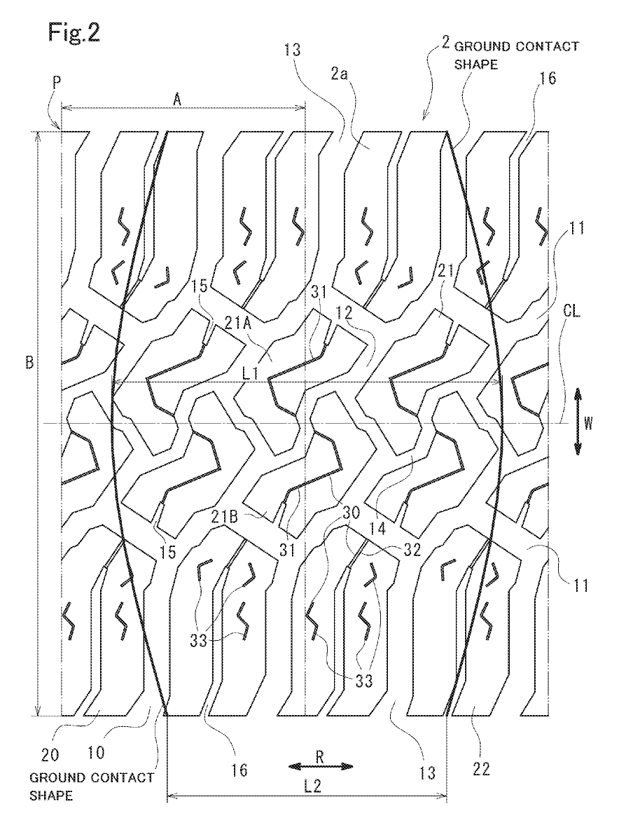

FIG. 2 is a plan view showing the tread portion 2 of the pneumatic tire 1 in a developed state. As shown in FIG. 2, a groove portions 10 are formed on the tread portion 2, and a plurality of land portions 20 are defined by the groove portions 10. The groove portions 10 include: a pair of circumferential-direction grooves 11, 11 extending in the tire circumferential direction R; and center lateral grooves 12 and shoulder lateral grooves 13 (width-direction grooves) both of which intersect with the pair of circumferential-direction grooves 11, 11 and extend in the tire width direction W.

In the present invention, the description “the groove extends in the tire circumferential direction R” includes not only the case where the groove extends parallel to the tire circumferential direction R but also the case where the groove extends in the tire circumferential direction R in a jig-zag shape or as an inclined manner with respect to the tire circumferential direction R. In the same manner, the description “the groove extends in the tire width direction W” includes not only the case where the groove extends parallel to the tire width direction W but also the case where the groove extends in the tire width direction W in a jig-zag shape or in an inclined manner with respect to the tire width direction W.

Each circumferential-direction groove 11 extends in the tire circumferential direction R in a jig-zag shape and is formed such that a see-through void which means that a ratio of an area where the land portion is not present when the circumferential-direction groove 11 is viewed in the tire-circumferential direction R zero. Each center lateral groove 12 extends in the tire width direction W a jig-zag shape, and makes the pair of circumferential-direction grooves 11, 11 communicate with each other. The shoulder lateral groove 13 is formed such that an end portion of the shoulder lateral groove 13 disposed inside in the tire width direction W communicates with the circumferential-direction groove 11, and other end portion of the shoulder lateral groove 13 extending to the outside in the tire width direction W communicates with an edge portion of the tread portion 2 in the tire width direction.

The land portion 20 includes: a plurality of center land portions 21 defined by the pair of circumferential-direction grooves 11, 11 and the center lateral grooves 12; and a plurality of shoulder land portions 22 defined by the circumferential-direction grooves 11 and the shoulder lateral grooves 13. A lug groove 14 which extends in the tire width direction in a jig-zag shape is formed in each center land portion 21. Each center land portion 21 is further divided into a first center land portion 21A and a second center land portion 21B in the tire width direction by the lug groove 14.

A center land portion slit 15 and a center land portion sipe 31 are formed in each of the first and second center land portions 21A, 21B. The description is made by taking the first center land portion 21A as an example. An end portion of each center land portion slit 15 disposed outside in the tire width direction communicates with the circumferential-direction groove 11, and the other end portion of each center land portion slit 15 extending to the inside in the tire width direction terminates in the first center land portion 21A. Each center land portion sipe 31 extends toward the inside of the first center land portion 21A in a jig-zag shape in the tire width direction W, and makes an end portion of the center land portion slit 15 disposed inside in the tire width direction W and the lug groove 14 communicate with each other.

A shoulder land portion slit 16, a shoulder land portion first sipe 32, and shoulder land portion second sipes 33 are formed on each shoulder land portion 22. Each shoulder land portion slit 16 is formed such that an end portion of the shoulder land portion slit 16 disposed outside in the tire width direction W communicates with the edge portion of the tread portion 2 in the tire width direction, and the other end portion the shoulder land portion slit 16 which extends toward the inside in the tire width direction W terminates in the shoulder land portion 22. The shoulder land portion first sipe 32 extends toward the inside in the tire width direction; and makes an end portion of the shoulder land portion slit 16 disposed inside in the tire width direction W and the circumferential-direction groove 11 communicate with each other.

The plurality of shoulder land portion second sipes 33 are formed on each shoulder land portion 22. The plurality of shoulder land portion second sipes 33 extend in the tire width direction while being bent. The plurality of shoulder land portion second sipes 33 communicate with neither the grooves 11 to 16 nor the sipes 31, 32, and are formed at the shoulder land portion 22.

As show in FIG. 2 where ground contact edge portions in the tire circumferential direction R when the pneumatic tire is brought into contact with a ground are indicated by a bold line, the tread portion 2 is formed to have a ground contact shape where a ground contact length in the tire circumferential direction at a center portion in the tire width direction is set larger than a ground contact length in the tire circumferential direction at both edge portions in the tire width direction W. To be more specific, a circumferential-direction ground contact length L2 between the width-direction ground contact edge portions at both edge portions in the tire width direction W is set smaller than a circumferential-direction ground contact length L1 on a tire equator. It is preferable that the ground contact length L2 is set to a value which is not smaller than 75% and not larger than 85% of the ground contact length L1.

The ground contact shape of the tread portion 2 is set such that effective ground contact area is set to a value which is not smaller than 65% and not larger than 75% of an area of a whole region of the ground contact shape. In other words, the tread portion 2 is formed such that a void ratio in the ground contact shape becomes a value which is not smaller than 25% and not larger than 35%.

The groove portions 10 mean groove portions which are formed by casting using a tire vulcanization mold, and have groove widths which do not allow groove walls to easily close the grooves when a pneumatic tire is brought into contact with a ground. For example, the groove portions 10 have groove widths of 2.0 mm or more, and more preferably have groove widths of 2.5 mm or more. That is, the groove portions 10 include the lug grooves 14, the center land portion slits 15 and the shoulder land portion slits 16 besides the circumferential-direction grooves 11, the center lateral grooves 12 and the shoulder lateral grooves 13.

The center land portion sipes 31, the shoulder land portion first sipes 32 and the shoulder land portion second sipes 33 are collectively referred to as “sipe portions 30” in the description made hereinafter. The sipe portion 30 means a cut which is formed by a tire vulcanization mold (for example, a cut formed by a sipe forming plate), and has a groove width which allows groove walls to easily close the groove when the pneumatic tire is brought into contact with a ground. For example, the sipe portion 30 has a groove width of 2.0 mm or less, and more preferably has a groove width of 1.5 mm or less.

In the present invention, a length component of the groove portions 10 in the tire width direction W and a length component of the groove portions 10 in the tire circumferential direction R per a unit area on an edge portion of the tread surface 2a are assumed as width-direction groove component LGD and a circumferential-direction groove component CGD respectively. A length component of the sipe portion 30 in the tire width direction W and a length component of the sipe portion 30 in the tire circumferential direction R per the unit area on the tread surface 2a are assumed as a width-direction sipe component LSD and a circumferential-direction sipe component CSD respectively. Further, an extending length of the sipe portion 30 per the unit area on the tread surface 2a is assumed as a whole sipe component ASD. The groove portions 10 and the sipe portions 30 are formed so as to satisfy the following relationships.

First, the width-direction groove component LGD is set larger than the circumferential-direction groove component CGD and the width-direction sipe component LSD. It is preferable that the width-direction groove component LGD be set to a value which is not smaller than 1.2 times and not larger than 3.0 times of the circumferential-direction groove component CGD. It is more preferable that the width-direction groove component LGD be set to a value which is not smaller than 1.5 times and not larger than 2.0 times of the circumferential-direction groove component CGD. The width-direction groove component LGD is set to a value which is not smaller than 1.2 times and not larger than 3.0 times of the width-direction sipe component LSD. It is more preferable that the width-direction groove component LGD be set to a which is not smaller than 1.5 times and not larger than 2.0 times of the width-direction sipe component LSD.

Next, the width-direction sipe component LSD is set larger than the circumferential-direction sipe component CSD. It is preferable that the width-direction sipe component LSD be set to a value which is not smaller than 1.2 times and not larger than 3.0 times of the circumferential-direction sipe component CSD. It is more preferable that the width-direction sipe component LSD be set to a value which is not smaller than 1.5 times and not larger than 2.5 times of the circumferential-direction sipe CSD.

The width-direction groove component LGD and the circumferential-direction groove component CGD are set to values which is not smaller than 0.010 mm/mm² and not larger than 0.040 mm/mm². The width-direction sipe component LSD and the circumferential-direction sipe component CSD are set to values which is not smaller than 0.005 mm/mm² and not larger than 0.0035 mm/mm². The whole sipe component ASD is set to a value which is not larger than 0.025 mm/mm².

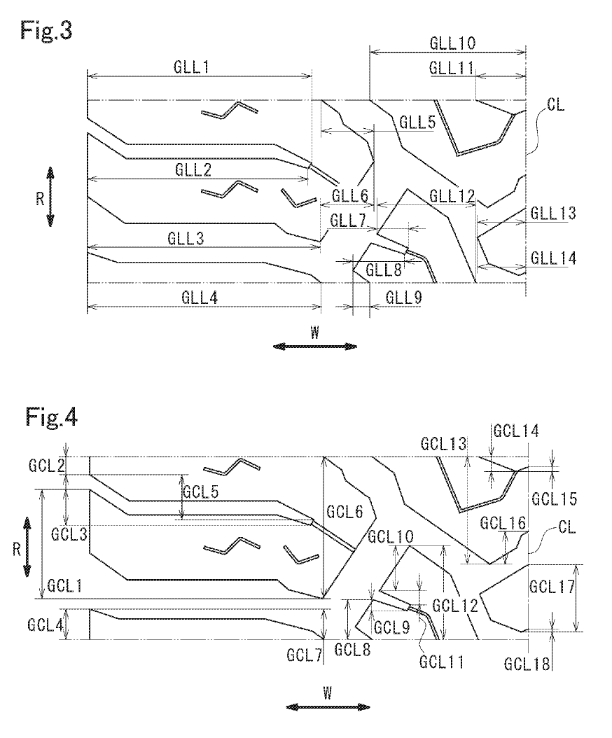

In the tread portion 2, assume a region having a tire circumferential direction length A and a tire width direction length B and is indicated by an imaginary line in FIG. 2 as a basic pattern P. A tread pattern of the tread portion 2 is formed by repeatedly arranging such a basic pattern P intervals of a circumferential direction length A. In this embodiment, the basic pattern P is formed in point symmetry with respect to a tire equator CL. Hereinafter, with reference to FIG. 3 to FIG. 6, the methods of acquiring the width-direction groove component LGD, the circumferential-direction groove component CGD, the width-direction sipe component LSD, the circumferential-direction sipe component CSD, and the whole sipe component ASD are described.

FIG. 3 to FIG. 6 are enlarged views respectively showing a portion of the basic pattern P in an enlarged manner, and show a ¼ region of the basic pattern P shown in FIG. 2 which is acquired by dividing the basic pattern P in two in the tire circumferential direction R as well as in two in the tire width direction W. In the description made hereinafter, by taking the ¼ region of the basic pattern P as an example, the methods of acquiring the width-direction groove component LGD, the circumferential-direction groove component CGD, the width-direction sipe component LSD, the circumferential-direction sipe component CSD, and the whole sipe component ASD are described.

First, with reference to FIG. 3, the width-direction groove component LCD is described. As shown in FIG. 3, with respect to the edge portions (groove edge portions) of the groove portions 10 on the tread surface 2a, respective length components GLL in the tire width direction W the projection thereof in the tire circumferential direction are acquired. In FIG. 3, the respective length components GLL are indicated as GLL1 to GLL14. A sum Σ GLL of the respective length components GLL of the groove portions 10 of the basic pattern P is acquired, and the sum Σ GLL is divided by a surface area (calculated by multiplying the tire circumferential direction length A by the tire width direction length B of the basic pattern P) of the basic pattern P so that the width-direction groove component LGD is calculated.

In the same manner, with reference to FIG. 4, the circumferential-direction groove component CGD is described. As shown in FIG. 4, with respect to edge portions (groove edge portions) of the groove portions 10 on the tread surface 2a, respective length components GCL in the tire circumferential direction R in the projection thereof in the tire width direction W are acquired. In FIG. 4, the respective length components GCL are indicated as GCL1 to GCL18. A sum Σ GCL of the respective length components GCL of the groove portions 10 of the basic pattern P is acquired, and the sum Σ GCL is divided by the surface area of the basic pattern P so that the circumferential-direction groove component CGD is calculated.

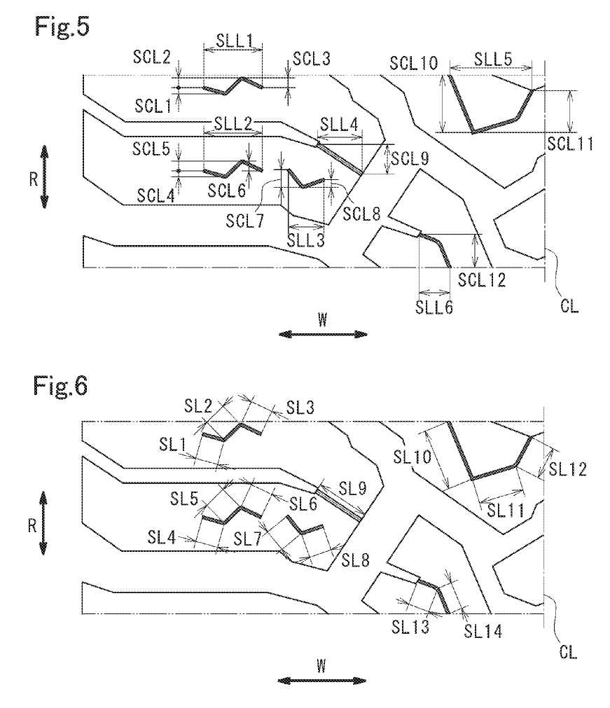

Next, with reference to FIG. 5, the width-direction sipe component LSD and the circumferential-direction sipe component CSD are described. As shown in FIG. 5, with respect to the sipe portions 30 which form groove center lines each of which halves the groove width on the tread surface 2a, length components SLL in the tire width direction W in the projection thereof in the tire circumferential direction R and length components SCL in the tire circumferential direction R in the projection thereof in the tire width direction W are acquired. In FIG. 5, the respective length components SLL are indicted as SLL1 to SLL6, and the respective length components SCL are indicted as SCL1 to SCL12.

A sum Σ SLL of the respective length components SLL of the sipe portion 30 in the basic pattern P is acquired, and the sum Σ SLL is divided by the surface area of the basic pattern P so that the width-direction sipe component LSD is calculated. In the same manner, a sum Σ SCL of the respective length components SCL of the sipe portion 30 in the basic pattern P acquired, and the sum Σ SCL is divided by the surface area of the basic pattern P so that the circumferential-direction sipe component CSD is calculated.

Next, with reference to FIG. 6, the whole sipe component ASD is described. As shown in FIG. 6, lengths SL of the sipe portions 30 which form groove center lines each of which halves the groove width on the tread surface 2a are acquired. In FIG. 6, the respective lengths SL are indicated as SL1 to SL14. A sum Σ SL of the respective lengths SL of the sipe portions 30 in the basic pattern P is acquired, and the sum Σ SL is divided by the surface area of the basic pattern P so that the whole sipe component ASD is calculated.

According to the pneumatic tire 1 which has been described heretofore, it is possible to acquire the following advantageous effects.

The width-direction groove component LGD is larger than the circumferential-direction groove component CGD and hence, it is possible to easily ensure the width-direction edge components on the tread surface 2a by the edge portions formed between the groove portions 10 and the tread surface 2a whereby the traction performance can be enhanced. Particularly, the traction performance on a snowy road can be easily ensured and hence, the pneumatic tire exhibits excellent snow traction performance. Accordingly, it is unnecessary to form a large number of sipes for enhancing traction performance and hence, the deterioration of external flaw resistance of the land portions 20 caused by the sipes can be suppressed. As a result, the pneumatic tire can acquire both the enhancement of snow traction performance and the enhancement of external flaw resistance.

The present invention can be preferably used as a tire for a so-called truck winch is used under a condition where a tire internal pressure is 550 kPa and a load is 1,450 kgf, for example. That is, according to the present invention, the width-direction groove component LGD of the groove portions 10 are increased and hence, snow traction performance can be preferably enhanced.

In an attempt to ensure a width-direction edge component by using mainly sipes, it is necessary to form a large number of sipes. Accordingly, with respect to a tire where an input to the tire is large, the rigidity of each block is liable to become insufficient and hence, wear resistance of land portions is deteriorated and chippings, cracks or the like are liable to occur in the block. On the other hand, when a width-direction edge component is ensured using the groove portions 10, the lowering of the rigidity of the land portion 20 can be easily suppressed. Accordingly, even with respect to a tire for a light truck where an input to the tire is large, the deterioration of wear resistance of the land portions is suppressed while snow traction performance is ensured, and chippings, cracks or the like in the land portion can be suppressed.

In the sipe portions 30, the width-direction sipe component LSD is larger than the circumferential-direction sipe component CSD. With such a configuration, a width-direction edge component formed by the sipe portion 30 can be easily ensured and hence, snow traction performance can be further enhanced.

The circumferential-direction groove 11 extends in a jig-zag shape such that a see-through void becomes zero. With such a configuration, a width-direction edge component of the circumferential-direction groove 11 can be increased and hence, snow traction performance can be further enhanced.

The groove portions 10 are formed such that the width-direction groove, component LGD is set to a value which is not smaller than 0.010 mm/mm² and not larger than 0.040 mm/mm² inclusive. With such a configuration, the groove portions 10 include a proper amount of width-direction groove component LGD and hence, it is possible to suppress the deterioration of external flaw resistance while snow traction is enhanced. When a width-direction groove component LGD is less than 0.010 mm/mm², the traction performance is liable to become insufficient. In addition, when the width-direction groove component LGD is larger than 0.040 mm/mm², the rigidity of the land portion 20 is liable to be lowered and hence, an effect of suppressing the deterioration of external flaw resistance is lowered.

The tread portion 2 is formed to have a ground contact shape where the circumferential-direction ground contact length L2 at both edge portions in the tire width direction W is smaller than the circumferential-direction ground contact length L1 on the tire equator. Further, the tread portion 2 is formed such that an effective ground contact area of the ground contact shape is set to a value which is not smaller than 65% and not larger than 75% of an area of a whole region of the ground contact shape. With such a configuration, the pneumatic tire of the present invention can ensure a proper ground contact surface shape while acquiring both the enhancement of snow traction performance and the enhancement of the external flaw resistance. Accordingly, the pneumatic tire of the present invention can suppress the deterioration of steering stability and uneven wear resistance.

With respect to the groove portions 10, each of the center lateral grooves 12, the shoulder lateral grooves 13, the lug grooves 14, the center land portion slits 15, and the shoulder land portion slits 16 all of which extend in the tire width direction has at least one end portion thereof in the tire width direction opened to the circumferential-direction groove 11 or to the edge portion of the tread portion 2 in the tire width direction. With such a configuration, when a vehicle travels on a snowy road, along with the rolling of the tire, snow can be easily introduced into the groove portions 10 extending in the tire width direction from the end portions of the circumferential-direction grooves 11 or the edge portions of the tread portion 2 in the tire width direction, and the snow introduced into the groove portions 10 can be discharged from the edge portions of the circumferential-direction groove 11 or the edge portions of the tread portion 2 in the tire width direction. Accordingly, it is possible to allow the groove portions 10 easily bite into a snowy road and hence, traction performance on a snowy road can be further enhanced.

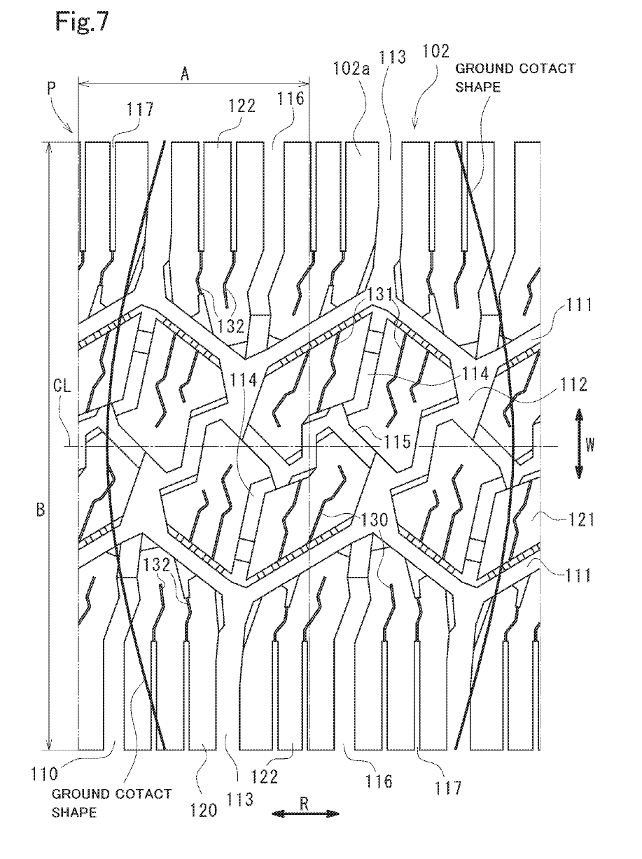

FIG. 7 shows a tread portion 102 according to a modification. As shown in FIG. 7, the tread portion 102 is partitioned into a plurality of land portions 120 by groove portions 110 thus having a tread pattern different from the tread pattern of the tread portion 2 according to the above-mentioned embodiment. To be more specific, a pair of circumferential-direction grooves 111, 111 which extend in the tire circumferential direction in a jig-zag shape, and a plurality of center lateral grooves 112 and a plurality of shoulder lateral grooves 113 both of which intersect with the circumferential-direction grooves 111, 111 and extend in the tire width direction are formed on the tread portion 102. Center land portions 121 and shoulder land portions 122 are defined by these grooves.

A width-direction lug groove 114 which extends in the tire width direction W, a circumferential-direction lug groove 115 which extends in the tire circumferential direction R, and a plurality of center sipes 131 which extend in the tire width direction W are formed on each center land portion 121. Shoulder lug grooves 116 which extend in the tire width direction, a plurality of shoulder slits 117 which extend in the tire width direction, and a plurality sipes 132 are formed on each shoulder land portion 122.

The shoulder lateral grooves 113 are formed such that each shoulder lateral groove 113 is continuously formed with the width-direction lug groove 114 at an intersecting portion between the shoulder lateral groove 113 and the circumferential-direction groove 111. The shoulder lug grooves 116 are formed such that each shoulder lug groove 116 is continuously formed with the center lateral groove 112 at an intersecting portion between the shoulder lug groove 116 and the circumferential-direction groove 111.

Also in the modification, the groove portions 110 include the circumferential-direction grooves 111, the center lateral grooves 112, the shoulder lateral grooves 113, the width-direction lug grooves 114, the circumferential-direction lug groove 115, the shoulder lug grooves 116, and the shoulder slits 117. Sipe portions 130 include center sipes 131 and shoulder sipes 132. Further, a width-direction groove component LGD, a circumferential-direction groove component CGD, a width-direction sipe component LSD, a circumferential-direction sipe component CSD, and a whole sipe component ASD satisfy substantially the same relationships as the above-mentioned embodiment.

### EXAMPLE

Tests for evaluating external flaw resistance, snow traction performance and wear resistance were carried out with respect to pneumatic tires of comparison examples 1 to 4 and pneumatic tires of examples 1 to 3 shown in the following Table 1.

TABLE 1

| | Comparative | Comparative | Comparative | Comparative | | | |
|---|---|---|---|---|---|---|---|
| | Example 1 | Example 2 | Example 3 | Example 4 | Example 1 | Example 2 | Example 3 |
| LGD | 0.010 | 0.040 | 0.040 | 0.040 | 0.040 | 0.030 | 0.020 |
| (mm/mm [symbol] ) | | | | | | | |
| LSD | 0.015 | 0.015 | 0.010 | 0.032 | 0.014 | 0.015 | 0.015 |
| (mm/mm²) | | | | | | | |
| CGD | 0.012 | 0.012 | 0.012 | 0.012 | 0.014 | 0.015 | 0.015 |
| (mm/mm²) | | | | | | | |
| CSD | 0.010 | 0.010 | 0.010 | 0.020 | 0.010 | 0.010 | 0.010 |
| (mm/mm²) | | | | | | | |
| ASD | 0.013 | 0.013 | 0.010 | 0.026 | 0.012 | 0.013 | 0.013 |
| (mm/mm²) | | | | | | | |
| LGD/CGD | 0.8 | 3.3 | 3.3 | 3.3 | 2.9 | 2.0 | 1.3 |
| LGD/LSD | 0.7 | 2.7 | 4.0 | 1.3 | 2.9 | 2.0 | 1.3 |
| External | ⊙ | ⊙ | ⊙ | X | ◯ | ⊙ | ⊙ |
| flaw | | | | | | | |
| resistance | | | | | | | |
| Snow | 100 | 130 | 130 | 130 | 130 | 120 | 110 |
| traction | | | | | | | |
| performance | | | | | | | |
| Wear | ⊙ | X | X | X | ◯ | ⊙ | ⊙ |
| resistance | | | | | | | |

[symbol]

indicates data missing or illegible when filed

In the pneumatic tire according to the comparison example 1, a width-direction groove component LGD is set to 0.010 mm/mm² which is smaller than a lower limit value (0.012 mm/mm²) in the above-mentioned embodiment. The width-direction groove component LGD is smaller than a circumferential-direction groove component CGD and a width-direction sipe component LSD. LGD/CGD is lower than 1.2.

In the pneumatic tire according to the comparison examples 2 and 3, a width-direction groove component LGD is set to 0.040 mm/mm² which is an upper limit value in the above-mentioned embodiment. The width-direction groove component LGD is larger than a circumferential-direction groove component CGD and a width-direction sipe component LSD. LGD/CGD is set to 3.3.

To be more specific, in the comparison example 2, the increase is observed only with respect to the width-direction groove component LGD compared to the comparison example 1, and LGD/LSD is set to 2.7. In the comparison example 3, the width-direction sipe component LSD in the decreased compared to the width-direction sipe component LSD in the comparison example 2, and LGD/LSD is set to 4.0. In the comparison example 4, all components related to sipes are increased compared to all components relating to sipes in the comparison example 2. LGD/CGD is set to 1.3.

In the pneumatic tire according to the example 1, a width-direction groove component LGD is set to 0.040 mm/mm² which is the upper limit value in the above-mentioned embodiment. The width-direction groove component LGD is larger than a circumferential-direction groove component CGD and a width-direction sipe component LSD. Both LGD/CGD and LGD/LSD are set to 2.9.

In the pneumatic tire according to the example 2, a width-direction groove component LGD is set to 0.030 mm/mm² which is a value smaller than the width-direction groove component LGD in the example 1. The width-direction groove component LGD is larger than a circumferential-direction groove component CGD and a width-direction sipe component LSD. Both LGD/CGD and LGD/LSD are set to 2.0.

In the pneumatic according to the example 3, a width-direction groove component LGD is set to 0.020 mm/mm² which is a value further smaller than the width-direction groove component LGD in the example 2. The width-direction groove component LGD is larger than a circumferential-direction groove component CGD and a width-direction sipe component LSD. Both LGD/CGD and LGD/LSD are set to 1.3.

Only in the pneumatic tire according to the example 4, the whole sipe component ASD is set to 0.026 which exceeds an upper limit value (0.024) in the above-mentioned embodiment.

The evaluation was made with respect to the pneumatic tires according to the comparison examples 1 to 4 and the pneumatic tires according to the examples 1 to 3 all of which have a tire size of LT285/70R17 and a index of 121. In an external flaw resistance test, each pneumatic tire was mounted on an actual light truck, and the truck traveled 500 km on an off-road under conditions where a tire internal pressure was set to 550 kPa, and a load was set to 1,450 kgf. Thereafter, a damage state on each tread surface was evaluated. When there was no damage on the tread surface, the evaluation “⊙” was given. When a small damage occurred on the tread surface at a minimum allowable level in practical use, the evaluation “◯” was given. When a damage occurred at a level that the damage caused a problem in practical use, the evaluation “×” was given.

Snow traction performance was evaluated under the condition which conforms to an ASTM snow traction condition (internal pressure: 340 kPa, load: 925 kgf). Assuming snow traction performance in the comparison example 1 as 100, snow traction performances of the remaining comparison examples 2 to 4 and the examples 1 to 3 are indicated by indexes. The larger index means, the more favorable snow traction performance was acquired.

The wear resistance was measured in such a manner that each pneumatic tire was mounted on an actual light truck, and the truck traveled 12,000 km under conditions where a tire internal pressure was 550 kPa and a load was 1,450 kgf and, thereafter, an amount of wear on each tread surface was measured. When no problem was found with respect to the amount of wear, the evaluation “⊙” was given. When wear occurred on the tread surface but the level of wear was at a level which caused no problem in practical use, the evaluation “◯” was given. When wear occurred on the tread surface and the level of wear at a level which caused a problem in practical use, the evaluation “×” was given.

In all pneumatic tires according to the comparison examples 2 to 4 where LGD/CGD exceeds 3.0, the evaluation “×” was given with respect to wear resistance. It is reasoned that the width-direction groove component was excessively large so that the rigidity of a land portion was lowered whereby the tread surface was easily worn. Further, in the pneumatic tire according to the comparison example 4, components relating to sipes were further increased and hence, the evaluation “×” was given with respect to external flaw resistance.

In the pneumatic tire according to the example 1, both LGD/CGD and LGD/LSD were set to 2.9 and hence, the rigidity of a land portion was not excessively lowered, and the pneumatic tire according to the example 1 exhibited both external flaw resistance and wear resistance at minimum allowable levels in practical use. In the pneumatic tires according to the examples 2 and 3, LGD/CGD and LGD/LSD were set smaller than LGD/CGD and LGD/LSD in the example 1 and hence, the degree of the lowering of the rigidity of a land portion was further smaller than that of the land portion in the example 1 so that the pneumatic tires according to the examples 2 and 3 exhibited more excellent external flaw resistance and wear resistance than those of the pneumatic tire according to the example 1.

With respect to snow traction performance, assuming snow traction performance in the comparison example 1 as a reference, the pneumatic tires according to the comparison examples 2 to 4 and the example 1 where the width-direction groove component LGD was set to an upper limit value (0.040 mm/mm²) in the above-mentioned embodiment exhibited the most excellent snow traction performances. In the pneumatic tires according to the examples 2, 3, along with the decrease of the width-direction groove component LGD from 0.040 mm/mm², an enhancement amount of the snow traction performance compared to the snow traction performance in the comparison example 1 was decreased.

What is claimed is:

1. A pneumatic tire where a tread portion includes a plurality of land portions formed by partitioning the tread portion by groove portions including a plurality of circumferential-direction grooves extending in a circumferential direction and a plurality of width-direction grooves extending in a width direction, and at least one sipe is formed on the land portion, wherein
assuming a length component of the groove portion in the width direction per a unit area on an edge of a tread surface as a width-direction groove component,
assuming a length component of the groove portion in the circumferential direction per the unit area on the edge of the tread surface as a circumferential-direction groove component,
assuming a length component of the sipe in the width direction per the unit area on the tread surface as a width-direction sipe component, and
the width-direction groove component is larger than the circumferential-direction groove component and the width-direction sipe component.

2. The pneumatic tire according to claim 1, wherein assuming a length component of the sipe in the circumferential direction per the unit area on the tread surface as a circumferential-direction sipe component, the width-direction sipe component is larger than the circumferential-direction sipe component.

3. The pneumatic tire according to claim 1, wherein the circumferential-direction groove extends in a jig-zag shape such that a see-through void becomes zero.

4. The pneumatic tire according to claim 1, wherein the width-direction groove component is set a value which is not smaller than 0.010 mm/mm² and not larger than 0.040 mm/mm².

5. The pneumatic tire according to claim 1, wherein a ground contact shape of the tread portion is set such that an effective ground contact area is set to a value which is not smaller than 65% and not larger than 75% of an area of a whole region of the ground contact shape, and a circumferential-direction ground contact length on a width-direction ground contact edge portion is set to a value which is not smaller than 75% and not larger than 85% of the circumferential-direction ground contact length on a tire equator.
